(19) United States
(12) Patent Application Publication
(10) Pub. No.: US 2026/0082123 A1
(43) Pub. Date: Mar. 19, 2026

(54) ELECTRONIC DEVICE FOR PERFORMING AUTOMATIC CAMERA SWITCHING AND OPERATING METHOD THEREOF

(71) Applicant: Samsung Electronics Co., Ltd., Suwon-si (KR)

(72) Inventors: Donghoon KIM, Suwon-si (KR); Jeongwon LEE, Suwon-si (KR); Yongkwan KIM, Suwon-si (KR); Daejong NOH, Suwon-si (KR); Sungkoo LEE, Suwon-si (KR); Seungtae HA, Suwon-si (KR)

(21) Appl. No.: 19/372,782

(22) Filed: Oct. 29, 2025

Related U.S. Application Data
(63) Continuation of application No. PCT/KR2025/014272, filed on Sep. 12, 2025.

(30) Foreign Application Priority Data
Sep. 13, 2024 (KR) 10-2024-0125345
Jul. 10, 2025 (KR) 10-2025-0093206

(51) Int. Cl. H04N 23/667; H04N 23/52; H04N 23/63; H04N 23/67; H04N 23/68; H04N 23/90; H04N 25/705

(52) U.S. Cl. CPC H04N 23/667; H04N 23/52; H04N 23/632; H04N 23/672; H04N 23/681; H04N 23/687; H04N 23/90; H04N 25/705

(57) ABSTRACT

An electronic device is provided. The electronic device includes a first camera supporting a first field of view (FoV), a second camera supporting a second field of view having a greater angle than the first field of view, a display, memory, including one or more storage media, storing instructions, and at least one processor comprising processing circuitry communicatively coupled to the first camera, the second camera, the display, and the memory, wherein the instructions, when executed by the at least one processor individually or collectively, cause the electronic device to, in a state where the second camera is inactivated, display a preview image on the display, based on an image obtained through the first camera, or store the image in a memory, obtain first depth information, based on phase difference information obtained using the first camera, activate the second camera, based on a value of the first depth information being less than a first threshold, after the second camera is activated, determine third depth information, based on at least one of the first depth information or second depth information obtained based on phase difference information obtained using the second camera.

### CROSS-REFERENCE TO RELATED APPLICATION(S)

This application is a continuation application, claiming priority under 35 U.S.C. § 365 (c), of an International application No. PCT/KR2025/014272, filed on Sep. 12, 2025, which is based on and claims the benefit of a Korean patent application number 10-2024-0125345, filed on Sep. 13, 2024, in the Korean Intellectual Property Office, and of a Korean patent application number 10-2025-0093206, filed on Jul. 10, 2025, in the Korean Intellectual Property Office, the disclosure of each of which is incorporated by reference herein in its entirety.

### TECHNICAL FIELD

The disclosure relates to an electronic device including a camera and an operating method thereof.

### BACKGROUND ART

An electronic device can generally have a plurality of cameras having different focal lengths and automatically switch a main camera according to certain conditions manually by user input or by an internal function. The electronic device requires distance information between the electronic device and a subject in order to switch the camera.

A distance between the electronic device and the subject can be measured as an absolute distance by a distance sensor (time-of-flight (ToF) and laser induced detection and ranging (LiDAR)). Due to being used simultaneously with a camera, operational problems occur, such as signal synchronization and a change of a corresponding point on an image dependent on distance. In addition, the distance sensor can require a separate mounting space and cause problems, such as additional power consumption and increased cost.

When camera focus information is used, a separate distance sensor may not be used, but the accuracy and stability of a switching operation can be reduced due to errors caused by the change of the characteristics of an optical system.

The above information is presented as background information only to assist with an understanding of the disclosure. No determination has been made, and no assertion is made, as to whether any of the above might be applicable as prior art with regard to the disclosure.

### DISCLOSURE

### Technical Problem

Aspects of the disclosure are to address at least the above-mentioned problems and/or disadvantages and to provide at least the advantages described below. Accordingly, an aspect of the disclosure is to provide an electronic device including a camera and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a first camera supporting a first field of view (FoV), a second camera supporting a second field of view having a greater angle than the first field of view, a display, memory, including one or more storage media, storing instructions, and at least one processor including processing circuitry communicatively coupled to the first camera, the second camera, the display, and the memory, wherein the instructions when executed by the at least one processor individually or collectively, cause the electronic device to, in a state where the second camera is inactivated, display a preview image on the display, based on an image obtained through the first camera, or store the image in the memory, obtain first depth information, based on phase difference information obtained using the first camera, activate the second camera, based on a value of the first depth information being less than a first threshold, after the second camera is activated, determine third depth information, based on at least one of the first depth information or second depth information obtained based on phase difference information obtained using the second camera, switch a camera used to display the preview image on the display or store the image in the memory, to the second camera, based on the activation of the second camera, and determine whether to switch the camera used to display the preview image on the display or store the image in the memory, to the first camera, based on the third depth information.

In accordance with another aspect of the disclosure, a method of operating an electronic device is provided. The method includes, in a state where a second camera is inactivated, displaying a preview image on a display, based on an image obtained through a first camera, or storing the image in a memory, obtaining first depth information, based on phase difference information obtained using the first camera, activating the second camera, based on a value of the first depth information being less than a first threshold, after the second camera is activated, determining third depth information, based on at least one of the first depth information or second depth information obtained based on phase difference information obtained using the second camera, switching a camera used to display the preview image on the display or store the image in the memory, to the second camera, based on the activation of the second camera, and determining whether to switch the camera used to display the preview image on the display or store the image in the memory, to the first camera, based on the third depth information.

In accordance with another aspect of the disclosure, one or more non-transitory computer-readable storage media storing one or more computer programs including computer-executable instructions that, when executed by one or more processors of an electronic device comprising a first camera and a second camera, individually or collectively, cause the electronic device to perform operations are provided. The operations include in a state where the second camera is inactivated, displaying a preview image on a display, based on an image obtained through the first camera, or storing the image in a memory, obtaining first depth information, based on phase difference information obtained using the first camera, activating the second camera, based on a value of the first depth information being less than a first threshold, after the second camera is activated, determining third depth information, based on at least one of the first depth information or second depth information obtained based on phase difference information obtained using the second camera, switching a camera used to display the preview image on the display or store the image in the memory, to the second camera, based on the activation of the second camera, and determining whether to switch the camera used to display the preview image on the display or store the image in the memory, to the first camera, based on the third depth information.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a camera module according to an embodiment of the disclosure;

FIG. 3 is a control block diagram of an electronic device according to an embodiment of the disclosure;

FIG. 4 is a flowchart illustrating an operating method of an electronic device according to an embodiment of the disclosure;

FIG. 5 is a flowchart illustrating a camera switching operating method of an electronic device according to an embodiment of the disclosure;

FIG. 6 is a diagram illustrating a signal flow of depth information of an electronic device according to an embodiment of the disclosure;

FIGS. 7A and 7B illustrate various error types that may occur for each camera switching direction and a flowchart of error types in an electronic device according to various embodiments of the disclosure;

FIG. 8 illustrates a 1^{st} error type that occurs when a camera switching direction of an electronic device is a first direction according to an embodiment of the disclosure;

FIG. 9 illustrates a 2-1^{th} error type that occurs when a camera switching direction of an electronic device is a first direction according to an embodiment of the disclosure;

FIG. 10 illustrates a 2-2^{th} error type that occurs when a camera switching direction of an electronic device is a first direction according to an embodiment of the disclosure;

FIG. 11 illustrates a 3rd error type that occurs when a camera switching direction of an electronic device is a second direction according to an embodiment of the disclosure;

FIG. 12 illustrates a 4-1^{th} error type that occurs when a camera switching direction of an electronic device is a second direction according to an embodiment of the disclosure;

FIG. 13 illustrates a 4-2^{th} error type that occurs when a camera switching direction of an electronic device is a second direction according to an embodiment of the disclosure;

FIG. 14 is a flowchart illustrating an operation of compensating for depth information, based on lens position information, in an electronic device according to an embodiment of the disclosure;

FIG. 15 is a control block diagram illustrating a depth information obtaining unit according to an embodiment of the disclosure; and

FIG. 16 is a flowchart illustrating dynamic calibration according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by appended claims and their equivalents.

It is to be understood that the singular forms “a,” “an,” and “the” include plural referents unless the context clearly dictates otherwise. Thus, for example, reference to “a component surface” includes reference to one or more of such surfaces.

Unless otherwise defined, all terms (including technical and scientific terms) used herein have the same meaning as commonly understood by one of ordinary skill in the art to which this disclosure belongs. Terms that are generally defined in dictionaries should be interpreted as having a meaning that is consistent with their ordinary usage in the art and should not be interpreted in an idealized or overly formal sense unless expressly so defined herein. The terminology used herein is intended to describe particular embodiments and is not intended to be limiting of the disclosure.

The terms “comprises” and/or “comprising,” as used herein, specify the presence of the stated features, integers, steps, operations, elements, and/or components, but do not preclude the presence or addition of one or more other features, integers, steps, operations, elements, components, and/or groups thereof.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

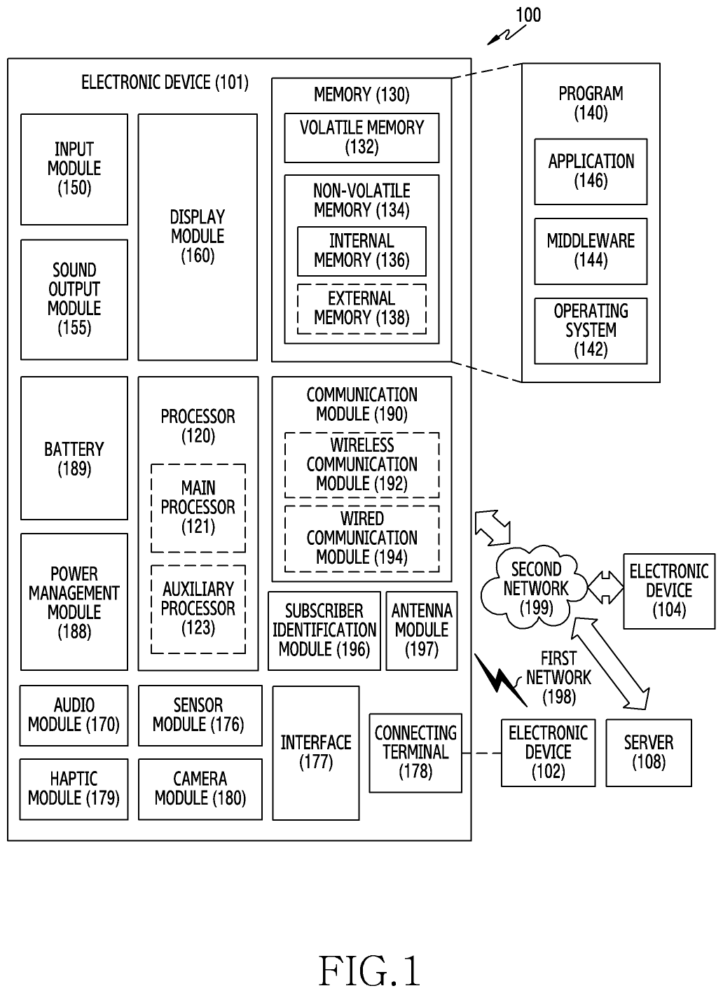

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an electronic device 104 or a server 108 via a second network 199 (e.g., a long-range wireless communication network). According to an embodiment of the disclosure, the electronic device 101 may communicate with the electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mm Wave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an Internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., a smart home, a smart city, a smart car, or healthcare) based on 5G communication technology or IoT-related technology.

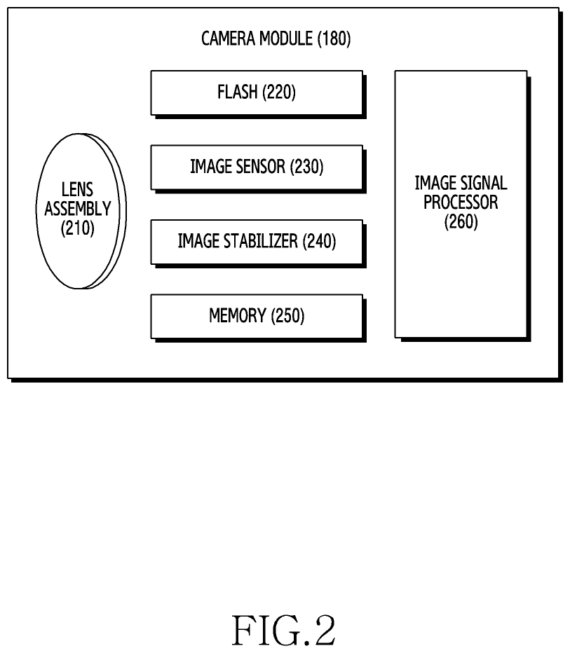

FIG. 2 is a block diagram 200 illustrating a camera module according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment of the disclosure, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment of the disclosure, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment of the disclosure, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device #01 including the camera module 180. This allows compensating for at least part of a negative effect (e.g., image blurring) by the movement on an image being captured. According to an embodiment of the disclosure, the image stabilizer 240 may sense such a movement by the camera module 180 or the electronic device #01 using a gyro sensor (not shown) or an acceleration sensor (not shown) disposed inside or outside the camera module 180. According to an embodiment of the disclosure, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment of the disclosure, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment of the disclosure, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment of the disclosure, the electronic device #01 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

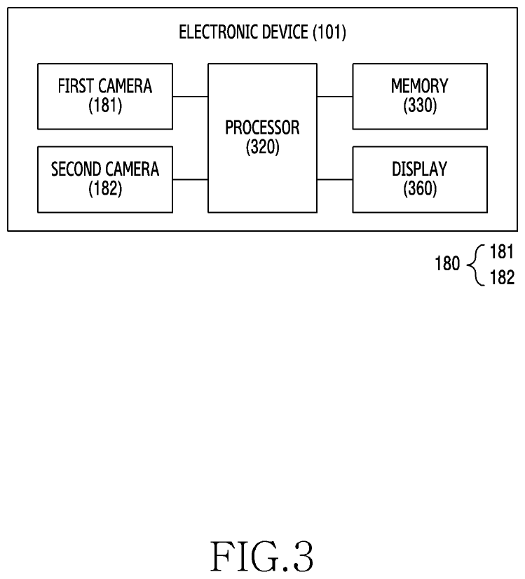

FIG. 3 is a control block diagram of an electronic device according to an embodiment of the disclosure.

Referring to FIG. 3, the overall operation of an electronic device 101 of an embodiment may be controlled by a processor 320. The processor 320 may control the operation of components provided for image capture in the electronic device 101. The specific control functions and operations of the processor 320 will be described later.

The electronic device 101 may include a first camera 181 and a second camera 182 for image capture. The first camera 181 and the second camera 182 may support different fields of view (FoV). According to an embodiment of the disclosure, the first camera 181 may support a first field of view, and the second camera 182 may support a second field of view that is greater than the first field of view. For example, the first camera 181 may be a wide camera, and the second camera 182 may be an ultra-wide camera. In addition, the first camera 181 may be a tele camera, and the second camera 182 may be a wide camera. In FIG. 3, for convenience of explanation, the disclosure is illustrated and described based on two cameras 180, but the electronic device 101 of an embodiment may include three cameras, and each camera may have a different field of view.

The first camera 181 of an embodiment may obtain first phase difference information wherein the processor 320 may obtain first depth information that is a distance to an object. In addition, the second camera 182 of an embodiment may obtain second phase difference information wherein the processor 320 may obtain second depth information that is the distance to the object. Here, although an actual distance between the electronic device 101 and the object is identical, the first depth information obtained through the first camera 181 may be different from the second depth information obtained through the second camera 182, since the phase difference information obtained from the first camera 181 is different from the phase difference information obtained from the second camera 182.

Memory 330 of an embodiment may store the first depth information and the second depth information (including the first phase difference information and the second phase difference information) obtained through the camera module 180. In addition, the memory 330 of an embodiment may store the first depth information and the second depth information together with an image obtained through the camera module 180.

A display 360 of an embodiment may output an image (including a preview image) obtained through the camera module 180.

An image sensor (e.g., image sensor 230 of FIG. 2) of the camera module 180 may obtain a phase difference. The image sensor 230 may obtain phase difference information through focus detection. In an example, the image sensor 230 may be provided in a matrix form. The arrangement of pixels in the image sensor 230 may be made wherein the image sensor 230 may obtain data for focus detection, and it is obvious that the arrangement of pixels may be changed in various ways by a person having ordinary knowledge in the art of this document.

The image sensor 230 may provide phase difference data. In particular, the phase difference data is information that is used for focus detection in a phase difference focus detection method, and may be used as focus information. For example, the focus information may include phase difference information provided by the image sensor 230. The phase difference data may be provided to the processor 320 through analog/digital (A/D) conversion. In addition, the operation of the image sensor 230 may be controlled by the processor 320 for processing the focus detection.

The processor 320 may control an operation for image capture. As the execution of a camera application is requested, the processor 320 may initiate the operation for image capture. The processor 320 may perform an auto focus (hereinafter, referred to as ‘AF’) detection operation. In response, the processor 320 may control the operation of the image sensor 230 of FIG. 2 and the image stabilizer 240 of FIG. 2, and detect auto focus of input image data. For example, the processor 320 may control the operation of the image sensor 230, and collect image data for focus detection. To this end, the processor 320 may adjust an exposure time, a sensitivity (ISO), a frame rate, or the like, of the image sensor 230, and may also issue a command to obtain high-resolution data for focus detection in a specific region. In addition, the processor 320 may operate the image stabilizer 240, and compensate for camera shake and support more accurate focus detection. For example, an image stabilization function may be activated in order to minimize image shake during an auto focus process. In addition, the processor 320 may temporarily stop or adjust the operation of the image stabilizer 240 in order to analyze a specific focus region more accurately. For example, the processor 320 may check a plurality of pieces of focus information (e.g., phase difference information) provided from the image sensor 230, based on a lens position (hereinafter, referred to as ‘initial lens position’), in an initial process of initiating an image capture operation of the electronic device 101. And, the processor 320 may estimate a lens position (hereinafter, referred to as ‘first lens position’) corresponding to a specified region (e.g., image center region or main subject region) (or region specified by a user input), based on the plurality of pieces of focus information (e.g., phase difference values). The processor 320 may check a relationship between the initial lens position and the estimated first lens position, and based on this, the processor 320 may check information (hereinafter, referred to as ‘lens movement information’) required to move a lens from the initial lens position to the estimated first lens position. For example, the lens movement information may include at least one of a lens movement direction, a lens movement distance, and a lens movement speed. By using the lens movement information, the processor 320 may move the lens to the estimated first lens position.

The image signal processor 260 of FIG. 2 may provide the focus information obtained in an operation of setting an automatic focus, or the lens movement information (e.g., lens movement direction, lens movement distance, lens movement speed, or the like), to the processor 320. And, when an AF function is performed, the processor 320 may generate a focus movement display user interface (UI) displaying the movement of the lens by using the focus information or the lens movement information (e.g., lens movement direction, lens movement distance, lens movement speed, or the like), and provide the generated user interface (UI) to the display 360.

The image sensor 230 included in the camera module 180 of an embodiment may obtain phase difference information about an external object by using image data generated from a plurality of light-receiving units (not shown), for example, a plurality of photodiodes.

The image sensor 230 of an embodiment may check the phase difference information about the external object by using the plurality of light-receiving units constituting one unit pixel. For example, the image sensor 230 may check the phase difference information about the external object by using two photodiodes (not shown) constituting one unit pixel.

The processor 320 of an embodiment may determine depth information, which is a distance to the external object, based on the phase difference information checked through the image sensor 230 and the external object checked using the plurality of light-receiving units consisting of the unit pixel.

When an input for image capture is detected, the processor 320 of an embodiment may combine two photodiodes and generate one image data. The unit pixel of the image sensor 230 may consist of two photodiodes or may consist of four photodiodes.

According to an embodiment of the disclosure, the camera module 180 may obtain an optical signal corresponding to an external object recognized through the image sensor 230. For example, the camera module 180 may check the phase difference information about the external object by using the plurality of light-receiving units, for example, at least two or more photodiodes (PDs), included in each pixel constituting a pixel array of the image sensor 230. For example, two or more PDs may be arranged under a micro lens. For example, in a 2PD method, a first PD and a second PD may be arranged, and in a 4PD method, a first PD, a second PD, a third PD, and a fourth PD may be arranged. A plurality of images may be obtained using information received from each photodiode (PD). For example, in the 2PD method, a first image obtained from the first PD and a second image obtained from the second PD may be generated, and in the 4PD method, each image may be generated in combination of the first PD and third PD and the second PD and fourth PD. A focus movement direction and a focus position may be determined by analyzing a phase difference between the obtained plurality of images. The phase difference may be determined by comparing a temporal or spatial difference between signals obtained from the respective PDs, and based on this, optimal focus adjustment may be performed. By using the detected phase difference information, the image sensor 230 may control a lens driving device (e.g., actuator), and through this, the image sensor 230 may perform automatic focusing and achieve optimal focus.

Based on the checked phase difference information, the processor 320 may obtain depth information between the electronic device 101 (or lens) and the external object. The processor 320 may store the depth information in the memory 330.

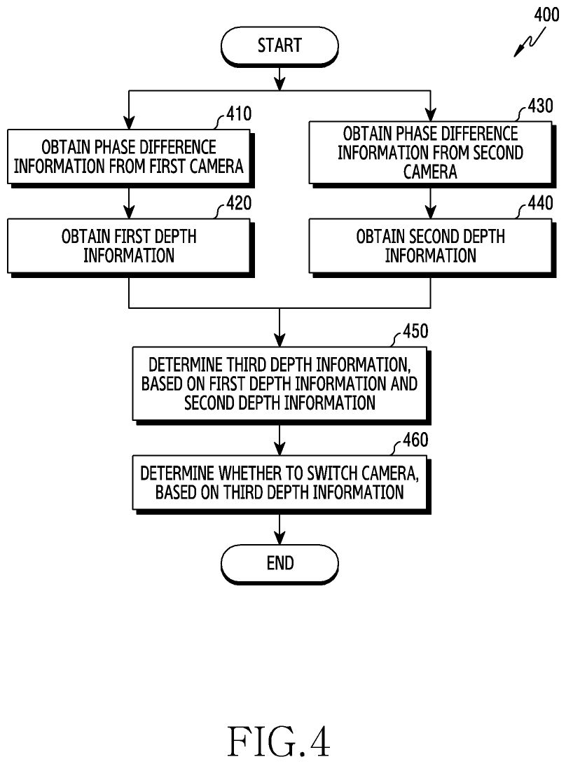

FIG. 4 is a flowchart 400 illustrating an operating method of an electronic device according to an embodiment of the disclosure.

Referring to FIG. 4, it illustrates an operation in a state where a first camera 181 and a second camera 182 are simultaneously activated. The simultaneous activation of the first camera 181 and the second camera 182 may occur temporarily in a camera switching process, and in a state where only one camera is activated, a distance may be measured based on third depth information.

The electronic device 101 of an embodiment may obtain phase difference information (first phase difference information) from the first camera 181 at operation 410, and obtain first depth information, based on the phase difference information at operation 420.

The electronic device 101 of an embodiment may obtain phase difference information (second phase difference information) from the second camera 182 at operation 430, and obtain second depth information, based on the phase difference information at operation 440.

The electronic device 101 of an embodiment may simultaneously activate the first camera 181 and the second camera 182 and simultaneously obtain the first depth information (and first phase difference information) and the second depth information (and second phase difference information). In addition, the electronic device 101 of an embodiment may also distinguish whether the distance to the external object gets far or near, activate only one camera among the first camera 181 and the second camera 182, and obtain only one piece of depth information. For example, in a state where the first camera 181 is inactivated, the electronic device 101 of an embodiment may activate only the second camera 182 and obtain the second depth information, or in a state where the second camera 182 is inactivated, the electronic device 101 may activate only the first camera 181 and obtain the first depth information.

The electronic device 101 of an embodiment may determine third depth information, based on the first depth information or the second depth information at operation 450. The third depth information may be information that becomes a reference for camera switching. The electronic device 101 may consider either the first depth information or the second depth information as the third depth information, and may select either the first camera 181 or the second camera 182, based on the third depth information.

Meanwhile, the third depth information may be the first depth information or the second depth information, but a compensation value may be reflected in the first depth information or the second depth information. Therefore, the third depth information may have a greater or smaller value than the first depth information or the second depth information. The compensation value is a value determined by a camera structure or an external factor, and a specific example thereof will be described later.

The electronic device 101 of an embodiment may determine whether to switch the camera, based on the third depth information at operation 460.

For example, while outputting an image (preview image) to the display 360 through the first camera 181, the processor 320 of an embodiment may inactivate the first camera 181 and activate the second camera 182 according to the change of the third depth information (e.g., decrease of a distance between the external object and the electronic device), and output an image obtained from the second camera 182 to the display 360. In addition, while outputting an image (preview image) to the display 360 through the second camera 182, the processor 320 of an embodiment may inactivate the second camera 182 and activate the first camera 181 according to the change of the third depth information (e.g., increase of the distance between the external object and the electronic device), and output an image obtained from the first camera 181 to the display 360.

For another example, while outputting an image (preview image) to the display 360 through the first camera 181, the processor 320 of an embodiment may maintain the activation of the first camera 181 according to the change of the third depth information (e.g., increase of the distance between the external object and the electronic device). In addition, while outputting an image (preview image) to the display 360 through the second camera 182, the processor 320 of an embodiment may maintain the activation of the second camera 182 according to the change of the third depth information (e.g., decrease of the distance between the external object and the electronic device).

According to an embodiment of the disclosure, the electronic device 101 may determine the third depth information, based on at least one of whether the first camera 181 is in an activated state, whether the second camera 182 is in an activated state, or a result of comparison between the first depth information and the second depth information.

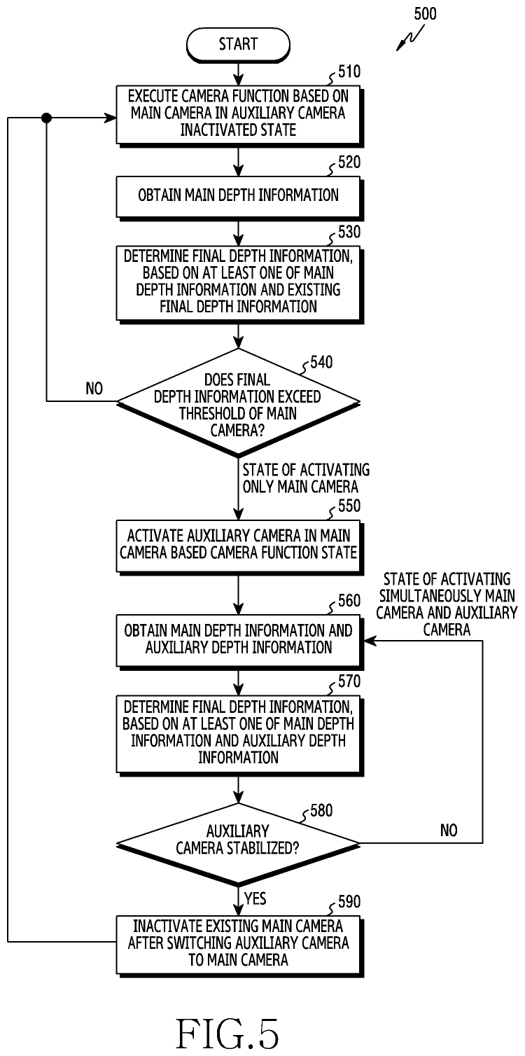

FIG. 5 is a flowchart 500 illustrating a camera switching operating method of an electronic device according to an embodiment of the disclosure.

The embodiment of FIG. 5 illustrates an embodiment of depth information determination and camera switching.

Referring to FIG. 5, a main camera is defined as a camera through which information is displayed on a display, an auxiliary camera is defined as a camera through which information is not displayed, and a first camera 181 and a second camera 182 may operate as the main camera and the auxiliary camera according to a switching operation. Here, when the first camera 181 is an ultra-wide camera, the second camera 182 may be a wide camera, when the first camera 181 is a tele camera, the second camera 182 may be a wide camera, or when the first camera 181 is a tele camera, the second camera 182 may be an ultra-wide camera.

An automatic switching function may repeatedly perform an operation of, when a user initially sets the first camera 181 as the main camera, automatically switching from the first camera 181 to the second camera 182 whose minimum focal length is relatively less in order to prevent image blurring caused at the time of shooting a close subject from occurring due to the limitation of the minimum focal length of the first camera 181, and then again returning to the first camera 181 when a distance gets far.

In a state where the auxiliary camera is inactivated, the electronic device 101 of an embodiment may execute a camera function that is based on the main camera at operation 510. For example, when a camera application is executed, the electronic device 101 of an embodiment may preferentially activate the first camera 181, and output an image (preview image) obtained through the first camera 181 to the display 360.

The electronic device 101 of an embodiment may obtain depth information (main depth information) through the main camera at operation 520. The depth information may be obtained through phase difference information, and refers to the contents already described above. Hereinafter, the main depth information may be depth information obtained from the main camera, and auxiliary depth information may be depth information obtained from the auxiliary camera.

The electronic device 101 of an embodiment may check whether final depth information exceeds a threshold at operation 540. Here, at operation 530, the main depth information and final depth information determined in a switching operation in a state where two cameras are activated simultaneously are stored and used as existing final depth information in a state where only the main camera is activated, and are ignored when there is no existing switching operation. Here, the threshold is a value determined based on the first camera 181 whose minimum focal length is relatively greater, and when a subject distance is less than the threshold, image blurring may occur since the first camera may not focus.

The minimum focal length refers to a length at which a lens of the first camera 181 or a lens of the second camera 182 may approach an external object the nearest, and refers to the minimum length between the lens and a subject, in which image blurring does not occur in the first camera 181 and the second camera 182, respectively. For example, the minimum focal length of a tele camera may be greater than the minimum focal length of a wide camera.

According to an embodiment of the disclosure, when the final depth information exceeds a threshold of the main camera at operation 540, the electronic device 101 may activate the auxiliary camera and prepare for camera switching at operation 550.

According to an embodiment of the disclosure, when it is determined at operation 540 that the final depth information does not exceed the threshold of the main camera, the electronic device 101 may obtain depth information, based on the main camera, without activating the auxiliary camera.

According to an embodiment of the disclosure, for a certain period of time for which the auxiliary camera is activated at operation 550 and stabilized in a switching process, the electronic device 101 may obtain two pieces of depth information (main depth information and auxiliary depth information) simultaneously with the main camera and the auxiliary camera at operation 560.

For example, the electronic device 101 may determine final depth information, based on at least one of the two pieces of depth information (main depth information and auxiliary depth information) simultaneously obtained for a certain period of time during a switching operation at operation 570.

According to an embodiment of the disclosure, when a subject distance exceeds the threshold of the main camera, and the auxiliary camera is activated and reaches a stabilized state after a certain period of time, the electronic device 101 may switch an image (preview image) displayed on a display, to the auxiliary camera. At this time, the electronic device 101 may inactivate the existing main camera, switch only the auxiliary camera to the main camera, and maintain an activated state at operation 590.

According to an embodiment of the disclosure, when it is determined at operation 580 that the auxiliary camera is not yet stabilized, the electronic device 101 may maintain the main camera and the auxiliary camera in an activated state simultaneously and continuously obtain the main depth information and the auxiliary depth information.

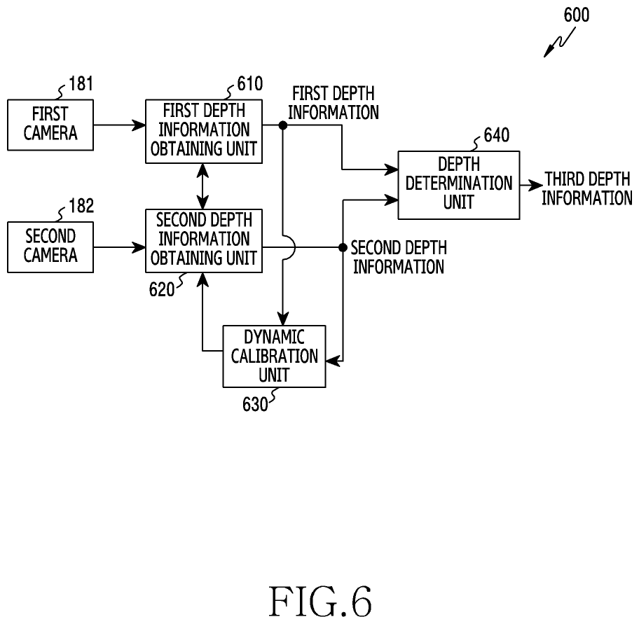

FIG. 6 is a diagram 600 illustrating a signal flow of depth information of an electronic device according to an embodiment of the disclosure.

The electronic device 101 of FIG. 1 of an embodiment may include a first camera 181 and a second camera 182 for image capture. The first camera 181 and the second camera 182 may support different fields of view (FoV). According to an embodiment of the disclosure, the first camera 181 may support a first field of view range, and the second camera 182 may support a second field of view range greater than the first field of view range.

Meanwhile, in FIG. 6, for convenience of explanation, the disclosure is illustrated and described based on two cameras, but the electronic device 101 of an embodiment may include a third camera (not illustrated), and each camera may have a different field of view range.

The electronic device 101 of an embodiment may select only one of the first camera 181 or the second camera 182 as the main camera, and obtain (or store) image and depth information through data obtained based on the main camera. The electronic device 101 of an embodiment may obtain third depth information for the purpose of automatic camera switching, based on an image obtained from the first camera 181, an image obtained from the second camera 182, phase difference information, lens position information, a compensation value, and/or temperature information.

Meanwhile, the electronic device 101 of an embodiment may include a first depth information obtaining unit 610 and a second depth information obtaining unit 620 for individually processing phase difference information obtained from each of the first camera 181 and the second camera 182 in order to determine the third depth information. The first depth information obtaining unit 610 may obtain first depth information, based on phase difference information obtained through an image sensor (not shown) included in the first camera 181. The second depth information obtaining unit 620 may obtain second depth information, based on phase difference information obtained through an image sensor (not shown) included in the second camera 182.

The first depth information obtaining unit 610 or the second depth information obtaining unit 620 of an embodiment may output each depth information and reliability, based on data input from a first camera (or second camera) having a relatively high distance accuracy and a second camera (or first camera) having a relatively low distance accuracy, a static/dynamic calibration coefficient of each camera, and additional information, such as sensing data and temperature data obtained from an inertia measurement unit (IMU).

A dynamic calibration unit 630 may, obtain a distance error by using the calibration coefficient for a distance and reliability for each region of interest (ROI) determined for each camera, determine a calibration coefficient value, and apply the calibration coefficient value to the first depth information or the second depth information, to obtain more accurate third depth information.

A depth determination unit 640 may determine either the first depth information or the second depth information as the third depth information. The criterion for determining the third depth information is based on a set threshold and is as described above in FIG. 5. The depth determination unit 640 may output the third depth information, which is final depth, based on each depth information (distance between the electronic device 101 and an external object) determined separately by the first depth information obtaining unit 610 and the second depth information obtaining unit 620. Meanwhile, in FIG. 6, it has been described that the final depth information (third depth information) is determined based on the depth information, but the final distance information may be determined based on the distance information, and camera switching may be performed based on the final distance information. The depth information may correspond to a relative defocus degree of a region of interest or a pixel within an image, and the distance information may correspond to a distance between the camera and the external object.

In a duration where the first camera 181 and the second camera 182 are turned on simultaneously in a camera switching process, a plurality of blocks 610 to 640 may operate, and when only one of the first camera 181 or the second camera 182 operates after the lapse of a certain period of time from the completion of switching, the depth information obtaining unit 610 or 620, the dynamic calibration unit 630, and/or the depth determination unit 640 that are associated with the camera having no input may be turned off.

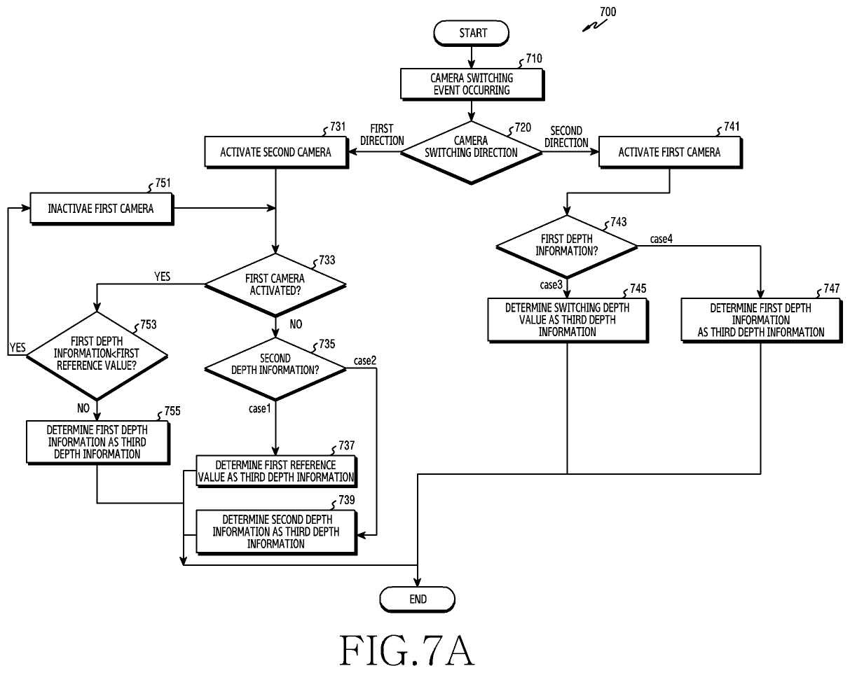

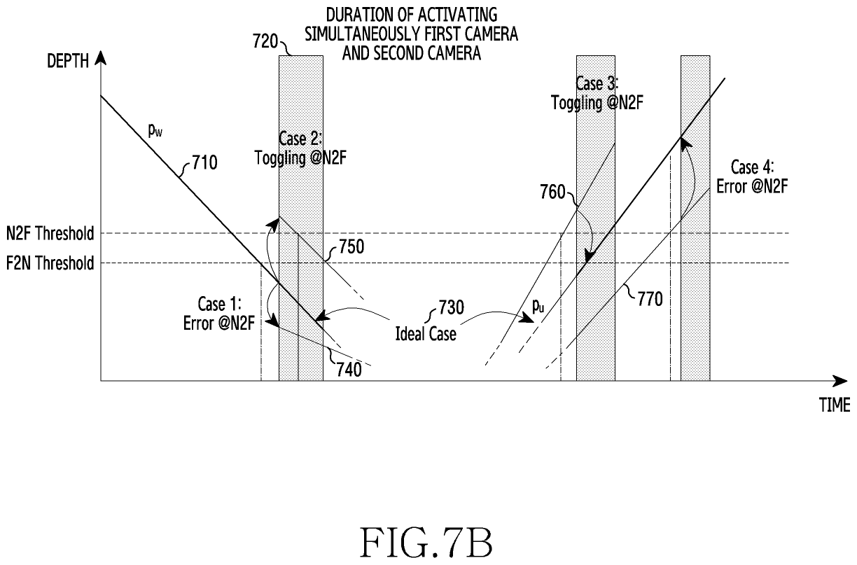

FIGS. 7A and 7B illustrate various error types that may occur for each camera switching direction and a flowchart 700 of the error types in an electronic device according to various embodiments of the disclosure.

Referring to FIGS. 7A and 7B, they illustrate cases that may occur according to depth information obtained from a first camera (Wide) and a second camera (Ultra Wide) at camera switching. In an initial state where the first camera (wide camera) is activated according to user's settings, when a subject distance gets near to a first threshold (F2N Threshold) or less, the second camera (ultra-wide camera) may be activated. At this time, the wide camera may be maintained as a main camera displayed on a display for a certain period of time, and in this duration, the wide camera and the ultra-wide camera may be activated simultaneously at operation 720 of FIG. 7B. In a first direction of switching from the wide camera to the ultra-wide camera, three cases are given according to depth values of the two cameras at operations 730, 740, and 750 of FIG. 7B. When the depth values of the two cameras are the same as each other at operation 730 of FIG. 7B, it is an ideal operation and no error occurs. On the other hand, when the depth value of the wide camera is large and the depth value of the ultra-wide camera is small at operation 740 of FIG. 7B, when the depth value of the ultra-wide camera is set as a third depth value, an error of switching at a distance greater than a second threshold (N2F Threshold) may occur at direction switching at operation 770 of FIG. 7B. When the depth value of the ultra-wide camera is greater than the depth value of the wide camera at operation 750 of FIG. 7B, a toggling may occur, since the third depth value, which is the depth value of the ultra-wide camera, is greater than the second threshold (N2F Threshold). Even in a second direction of switching from the ultra-wide camera to the wide camera at operations 730, 760, and 770 of FIG. 7B, when two values are the same as each other, it is an ideal operation at operation 730 of FIG. 7B. When the depth value of the ultra-wide camera is greater than the depth value of the wide camera at operation 760 of FIG. 7B, switching may occur at a distance less than the second threshold (N2F Threshold). At this time, when the depth value of the wide camera is set as the third depth value, a toggling error may occur again at operation 760 of FIG. 7B, when the depth value of the wide camera is less than the first threshold (F2N Threshold). In the opposite case, an error of switching at a distance greater than the second threshold (N2F Threshold) may occur at operation 770 of FIG. 7B.

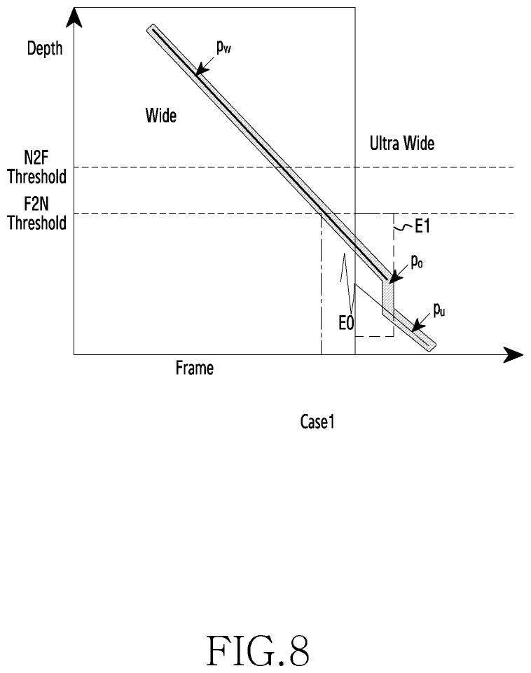

FIGS. 8 to 13 illustrate a third depth (po) detection method for, when the first camera is a wide camera and the second camera is an ultra-wide camera, referring to at least one piece of information according to each case and preventing the occurrence of a toggling or switching distance error according to various embodiments of the disclosure.

Referring to FIGS. 8 to 13, ‘pw’, ‘pu’, and ‘po’ represent the first depth information, the second depth information, and the third depth information of FIG. 6. At an initial time when an ultra-wide camera is activated in a first direction switching process, a duration in which depth information is inaccurate occurs (E0), due to an unstable transition duration.

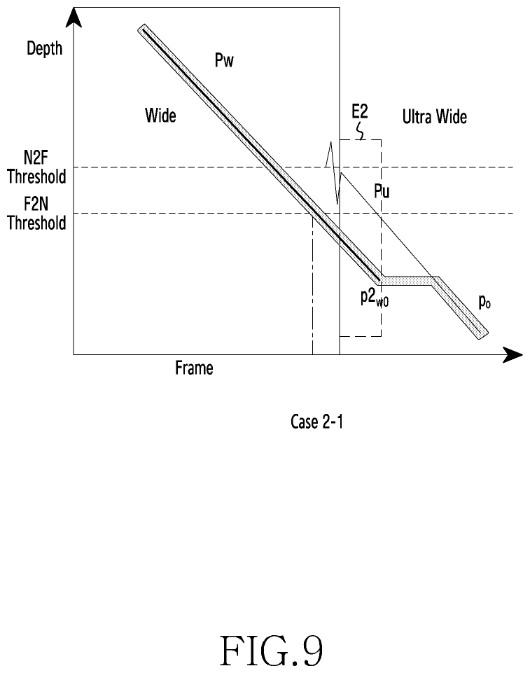

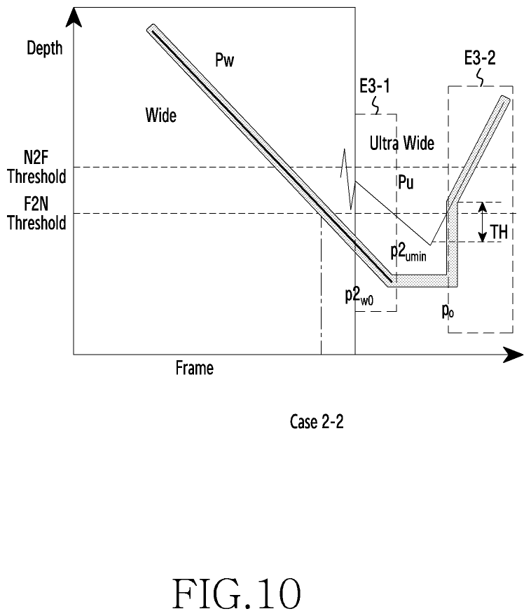

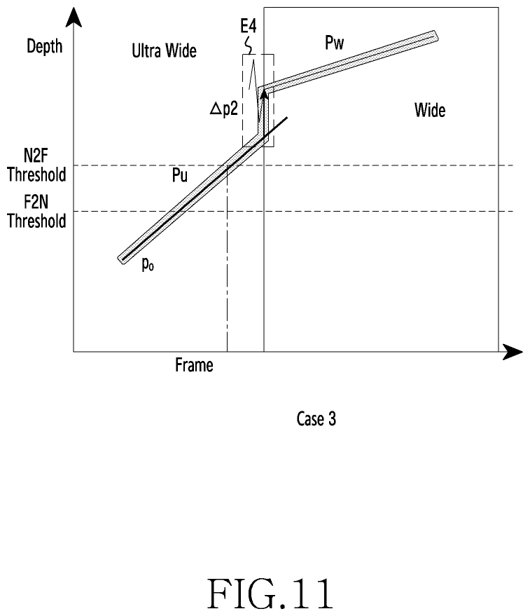

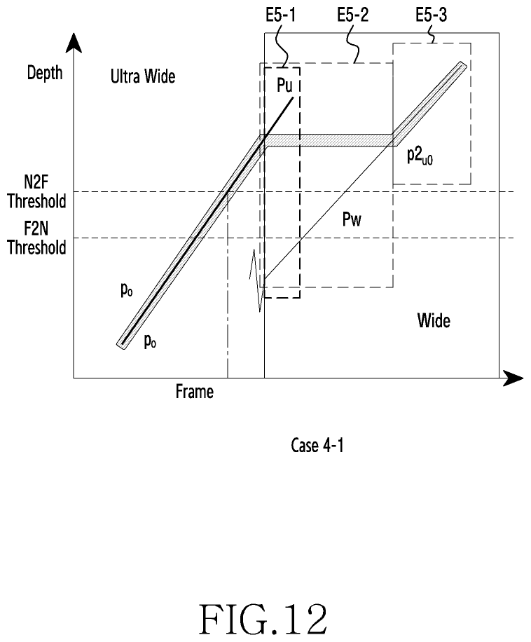

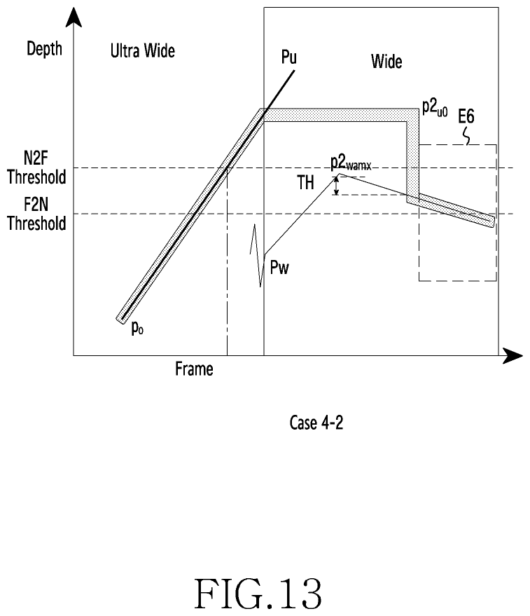

FIG. 8 illustrates a 1^{st} error type (Case 1) that occurs when a camera switching direction of an electronic device is a first direction according to an embodiment of the disclosure, FIG. 9 illustrates a 2-1^{th} error type (Case 2-1) that occurs when the camera switching direction of the electronic device is the first direction according to an embodiment of the disclosure, FIG. 10 illustrates a 2-2^{th} error type (Case 2-2) that occurs when the camera switching direction of the electronic device is the first direction according to an embodiment of the disclosure, FIG. 11 illustrates a third error type (Case 3) that occurs when the camera switching direction of the electronic device is a second direction according to an embodiment of the disclosure, FIG. 12 illustrates a 4-1^{th} error type (Case 4-1) that occurs when the camera switching direction of the electronic device is the second direction according to an embodiment of the disclosure, and FIG. 13 illustrates a 4-2^{th} error type (Case 4-2) that occurs when the camera switching direction of the electronic device is the second direction according to an embodiment of the disclosure. Various error types of FIG. 7B are described with reference to FIGS. 8 to 13.

According to an embodiment of the disclosure, an electronic device 101 may detect the occurrence of a camera switching event at operation 710 of FIG. 7A. The camera switching event may occur to determine a camera for outputting an image (preview image) or determine depth information used in the image, when a distance between the electronic device 101 and an external object gets far or near.

The camera switching event may occur when third depth information decreases less than a first threshold (F2N Threshold) during the execution of a camera function based on a first camera, or when the third depth information exceeds a second threshold (N2F Threshold) during the execution of a camera function based on a second camera. The first threshold (F2N Threshold) may be set to a certain margin of a value smaller than the second threshold (N2F Threshold) and prevent a toggling caused by a noise by using a hysteresis threshold.

According to an embodiment of the disclosure, the electronic device 101 may determine a camera switching direction at operation 720 of FIG. 7A. Here, a first direction is when the distance between the electronic device 101 and the external object gets near (far to near (F2N)), and means the case of switching from a first camera 181 to a second camera 182, and a second direction is when the distance between the electronic device 101 and the external object gets far (near to far (N2F)), and means the case of switching from the second camera 182 to the first camera 181.

When the camera switching direction is the first direction, the electronic device 101 of an embodiment may activate the second camera 182 at operation 731 of FIG. 7A. The second camera 182 has the minimum focal length less than that of the first camera 181, and may prevent blurring that may occur at the time of shooting with the first camera 181 when the distance between the electronic device 101 and the external object relatively gets near.

In an embodiment of the disclosure, when the first camera 181 is not activated at operation 733 of FIG. 7A or second camera activation duration of FIG. 7B, the electronic device 101 may check second depth information obtained through the second camera 182 at operation 735 of FIG. 7A or operations 760 and 770 of FIG. 7B. According to an embodiment of the disclosure, the electronic device 101 may determine, as the third depth information, a first reference value instead of the second depth information obtained through the second camera 182 at operation 737 of FIG. 7A or operation 740 of FIG. 7B.

Regarding this, referring to FIG. 9, in an E2 duration of a duration of switching from the first camera (Wide) to the second camera (Ultra Wide), a first reference value p2_{w0}, which is the existing last depth information obtained from the first camera, may be determined as the third depth information, which is final depth information. In the E2 duration, although the second camera is actually activated, the last depth information (first reference value) obtained from the first camera having a relatively high distance accuracy may be maintained as the third depth information since there is a gap between depth information obtained from the first camera and depth information obtained from the second camera, and at a time when the second depth has the same value as the third depth information, the third depth information may follow the second depth value, thereby preventing an unnecessary camera toggling.

In an embodiment of the disclosure, when the first camera 181 is not activated at No of operation 733 of FIG. 7A), the electronic device 101 may check the second depth information obtained through the second camera 182 at operation 735 of FIG. 7A. According to an embodiment of the disclosure, the electronic device 101 may determine, as the third depth information, the second depth information obtained through the second camera 182 at operation 739 of FIG. 7A. Regarding this, referring to FIG. 9, after the depth information is applied based on the first reference value p2_{w}0 for a certain period of time in the E2 duration of the duration of switching from the first camera (Wide) to the second camera (Ultra Wide), the reliability of the depth information based on the second camera may be increased. Therefore, in a duration after E2, the second depth information obtained from the second camera may be determined as the third depth information.

According to an embodiment of the disclosure, when the camera switching direction is the first direction (when the distance between the electronic device and the subject gets near), in a state where the first camera 181 is activated after the second camera 182 is activated, the electronic device 101 may determine the first depth information as the third depth information. When the first depth information reaches the first reference value p2_{w0}, the electronic device 101 of an embodiment may inactivate the first camera 181 (duration after E2 of FIG. 9 or duration between E3-1 and E3-2 of FIG. 10). And, after the first camera 181 is inactivated, the electronic device 101 may determine the first reference value p2_{w0} as the third depth information (duration after E2 of FIG. 9), based on the second depth information being greater than the first reference value p2_{w0}. According to an embodiment of the disclosure, the electronic device 101 may determine the second depth information as the third depth information (E3-2 duration of FIG. 10), based on the second depth information being less than or equal to the first reference value p2_{w0} or the difference between the second depth information and the minimum value of the second depth information being greater than the second threshold (N2F Threshold).

Meanwhile, according to an embodiment of the disclosure, FIG. 10 illustrates that at first direction switching, the second depth is greater than the first depth, and a camera movement direction from a subject is changed in a state where the first camera is inactivated after the E3-1 duration. In Case 2-1 of FIG. 9, since the camera movement direction is unchanged, the difference between the second depth and the third depth decreases according to the lapse of time, but in Case 2-2 of FIG. 10, since the camera movement direction is changed, the difference between the second depth and the third depth value increases. Even in this case, in order to prevent toggling, the third depth follows the second depth, when it gets far from a certain threshold (TH) or more compared to the minimum value p2ᵤₘᵢₙ.

In a state where the first camera 181 is activated at Yes of operation 733 of FIG. 7A (first camera activation duration of FIG. 7B), the electronic device 101 may check whether the first depth information is less than the first reference value p2_{w0} at operation 753 of FIG. 7A. In this embodiment of the disclosure, the second camera 182 may be in an activated state and then the first camera 181 may be in an activated state together with the activation of the second camera 182, or the first camera 181 may be in an activated state again after being inactivated at operation 751 of FIG. 7A based on the first depth information being less than the first reference value p2_{w0} at Yes of operation 753 of FIG. 7A. In an embodiment of the disclosure, when the first depth information is not less than the first reference value p2_{w0}, the electronic device 101 may determine the first depth information as the third depth information at operation 755 of FIG. 7A. For example when the first depth information is greater than the first reference value p2_{w0} and thus has a significant gap with the depth information obtained from the second camera 182, the electronic device 101 may determine the first depth information as the final depth information to prevent future toggling. Relevant cases may be the E1 duration of FIG. 8, a duration before E2 of FIG. 9, and the E3-1 duration of FIG. 10.

FIG. 8 illustrates a process of switching from a main camera (Wide) to an auxiliary camera (Ultra Wide). Initially, first depth information Pw of the main camera continuously decreases, and eventually the first depth information Pw falls below the first threshold (F2N Threshold). When the first depth information Pw falls below the first threshold, the electronic device 101 may obtain second depth information Pu of the auxiliary camera. Immediately after switching, there may be a temporary distance difference between the main camera and the auxiliary camera, but the electronic device 101 may perform stable camera switching without toggling, in that the electronic device 101 performs the camera switching, based on third depth information Po (see FIG. 6).

When the camera switching direction is a second direction, the electronic device 101 of an embodiment may activate the first camera 181 at operation 741. This operation is an operation of, when the distance between the electronic device 101 and the external object is relatively far, returning to the first camera 181 initially set by a user, in that the first camera 181 has a relatively smaller angle of field of view than the second camera 182.

In an embodiment of the disclosure, the electronic device 101 may check the first depth information from the first camera 181 at operation 743.

In an embodiment of the disclosure, the electronic device 101 may determine a switching depth value (p2ᵤ₀ of FIG. 12) as the third depth information at operation 745 of FIG. 7A. Regarding this, referring to FIG. 12, after switching from the second camera 182 to the first camera 181, when the first depth information of the first camera 181 is less than the first threshold (F2N Threshold) (E5-1 duration), a toggling may occur, when the third depth information follows the first depth. Therefore, the electronic device 101 may determine the switching depth value, which is the last depth information at camera switching, as the third depth information.

In an embodiment of the disclosure, in a state where the first camera is inactivated and the second camera is activated, the electronic device 101 may activate the first camera (‘wide’ duration of FIGS. 12 and 13), based on the second depth information being greater than the second threshold (N2F Threshold). Based on the first camera being activated, the electronic device 101 may switch a camera used to display a preview image on a display or store an image in a memory, to the first camera, when the third depth information is the switching depth value. After the first camera is activated, the electronic device 101 may determine the switching depth value as the third depth information (E5-2 of FIG. 12), based on the first depth information being less than the switching depth value. In addition, based on the first depth information being greater than or equal to the switching depth value or the difference between the maximum value of the first depth information and the first depth information being greater than or equal to the fourth threshold (TH of FIG. 10 or TH of FIG. 13), the electronic device 101 may determine the first depth information as the third depth information, and prevent toggling that may occur when the camera movement direction changes.

Meanwhile, FIG. 13 illustrates a case where, after switching from a main camera (Ultra Wide) to an auxiliary camera (Wide), depth information of the auxiliary camera is obtained unstably and results in a malfunction risk. When depth information of the main camera increases and exceeds a second threshold (N2F Threshold), the electronic device 101 may perform the switching from the main camera to the auxiliary camera. The initial depth information Pw obtained from the auxiliary camera immediately after the switching has a significant difference from the depth information obtained from the main camera. In this case, the electronic device 101 may perform the camera switching, based on the depth information of the main camera, until the change of the depth information in a reversed direction is greater than or equal to a certain value TH.

According to an embodiment of the disclosure, the electronic device 101 may determine whether to switch a camera used to display a preview image on the display or store an image in the memory, to the second camera, based on the third depth information.

Meanwhile, the above description has been made for embodiments in which at least one of the first depth information and the second depth information is determined as the third depth information when a camera switching event occurs. By applying a compensation value to the first depth information or the second depth information before determining the third depth information, the electronic device 101 may derive more accurate third depth information. Hereinafter, a description is made for a method for detecting in real time an error that may occur during a camera operation process and changing a calibration coefficient, thereby minimizing the error and preventing malfunctions in various situations.

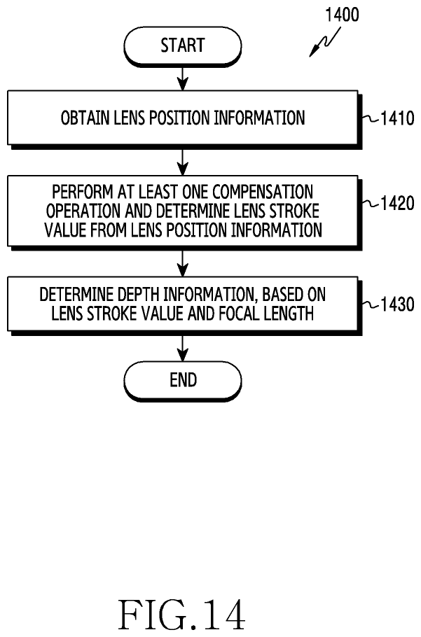

FIG. 14 is a flowchart 1400 illustrating an operation of compensating for depth information, based on lens position information, in an electronic device according to an embodiment of the disclosure.

For example, a lens of a camera may move according to focus by an actuator, and the position of the moved lens may be detected by a Hall sensor included in a camera module. Meanwhile, when a positional difference occurs due to a slight gap difference between mechanism structures for fixing the lens, the lens may move due to gravity. When the amount of lens movement changed due to gravity is not accurately detected by the Hall sensor, an error may occur in first depth information and/or second depth information. Therefore, there is a need for compensation taking into account the positional difference of the lens.

According to an embodiment of the disclosure, the electronic device 101 may obtain lens position information at operation 1410. The lens position information may be obtained through a signal of the Hall sensor included in the camera module.

According to an embodiment of the disclosure, the electronic device 101 may perform at least one compensation operation, and determine a lens stroke value from the lens position information at operation 1420. The lens position information may correspond to an absolute position of the lens determined by an optical image stabilization (OIS) or auto focus (AF) function. For example the lens position information represents a coordinate or physical position where the lens is currently positioned within an optical system, and this may be controlled by a lens drive device (actuator, or the like). For example, an OIS system may move the lens to a specific position in order to compensate for external vibration or movement, and an AF system may move the lens forward or backward in order to focus on a subject. The lens position information measured in this process may be stored and utilized as an absolute spatial position value of the lens. Meanwhile, the lens stroke value (based on AF axis) may correspond to a relative value of the actual movement of the lens. For example the lens stroke value may be defined as a value representing a movement distance or displacement of the lens compared to a specific reference position (e.g., initial lens position). This is a value for quantitatively measuring the change of a lens position, and may reflect a relative position change that occurs according to a specific lens drive command (e.g., AF drive, OIS adjustment). For example, when the lens moves forward 0.5 mm from its initial position, the lens stroke value may be recorded as +0.5 mm, and when the lens moves backward, the lens stroke value may be represented as a negative value.

The at least one compensation operation may include an operation of processing a bilateral filter for reducing noise by averaging highly correlated regions of interest (ROIs) when there are a plurality of regions of interest (ROIs) in an image, an operation of synchronization compensation for removing a spike noise value that occurs when obtaining depth information for each image frame and obtaining an average value, an operation of defocus compensation for obtaining depth information by limiting a region of interest to a certain region, an operation of distortion compensation for obtaining depth information by considering that the amount of defocus is varied depending on an image height, which is a distance from the center of the image, based on the characteristics of the lens, an operation of hysteresis compensation that considers a movement amount error that occurs depending on a movement direction due to the mechanical characteristics of a lens actuator, an operation of lens position compensation that considers a positional difference of the lens, and an operation of temperature compensation that considers the change of a refractive index depending on the temperature of the lens. Here, the temperature compensation may be estimated indirectly through a temperature of an image sensor since it is difficult to directly measure the temperature of the lens itself.

According to an embodiment of the disclosure, the electronic device 101 may determine depth information, based on the lens stroke value and/or a focal length at operation 1430. Here, the lens stroke value may be a value obtained by reflecting at least one compensation operation described above. Therefore, the depth information determined at operation 1430 corresponds to a value obtained by reflecting a compensation value in the first depth information and/or the second depth information. A focal position may correspond to a position of at least one lens related to a focus of a lens unit consisting of a plurality of lenses. For example a position where a focus is formed may be determined according to the arrangement and movement of an individual lens in the lens unit. In addition, the position of the lens may be adjusted through physical movement of the lens, and by using a control value (e.g., lens position, lens movement amount, stroke, or the like) for controlling this, the arrangement and movement of the lens may be adjusted.

According to an embodiment of the disclosure, the electronic device 101 may obtain lens position information from the first camera (or second camera), and synchronize the lens position information with phase difference information obtained from the first camera (or second camera). Here, the lens position information may be obtained through the Hall sensor, or the like, included in the camera. The electronic device 101 may obtain first depth information (or second depth information), based on the lens position information synchronized with the phase difference information.

According to an embodiment of the disclosure, the electronic device 101 may obtain the lens position information from the first camera (or second camera) and, based on the lens position information, the electronic device 101 may determine a compensation value for compensating for hysteresis for the first camera (or second camera). Based on the determined compensation value, the electronic device 101 may obtain the first depth information (or second depth information).

According to an embodiment of the disclosure, the electronic device 101 may obtain movement information about the movement of the electronic device 101, and determine a compensation value, based on the movement information. The electronic device 101 may obtain the first depth information (or second depth information), based on the determined compensation value.

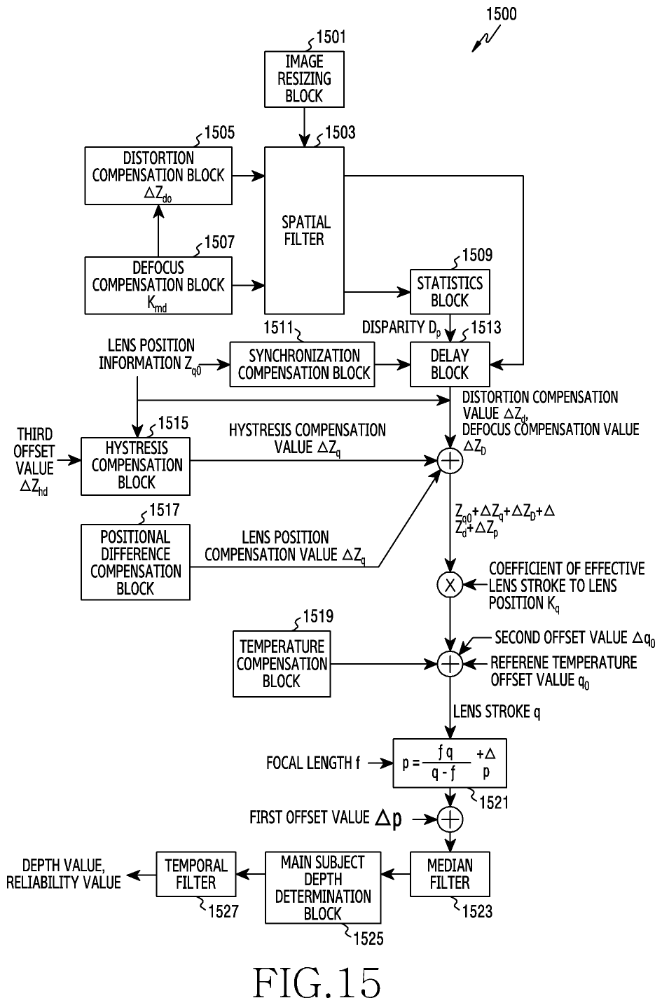

FIG. 15 is a control block diagram illustrating a depth information obtaining unit 1500 according to an embodiment of the disclosure.

Referring to FIG. 15, the depth information obtaining unit 1500 may include the first depth information obtaining unit 610 or the second depth information obtaining unit 620 of FIG. 6.

First, the depth information obtaining unit 1500 may receive image data from a camera (first camera or second camera), change an image size by the unit of pixels through image resizing 1501, and transfer to a spatial filter (bilateral filter) 1503. The spatial filter 1503 may obtain a correlation coefficient between a plurality of regions of interest (ROIs) in an image and average at least one ROI based on a correlation, thereby reducing a noise of an image signal.

A distortion compensation 1505 may provide the spatial filter 1503 with a compensation value Δz_{d0} for compensating for defocus according to an image height, which is a distance from the center of the image, due to the characteristics of a lens.

A defocus compensation 1507 may provide the spatial filter 1503 with a compensation value k_{md} for compensating for depth information by limiting a region of interest to a certain region.

A statistics 1509 may obtain disparity Dₚ and reliability R_{b0}, based on the sum of absolute difference (SAD) in which noise is reduced by the spatial filter 1503.

A compensation value Δz_{d0} for compensating for defocus and a compensation value k_{md} that is a coefficient for converting the amount of defocus in disparity may have different values for each ROI and therefore, may be processed by the spatial filter 1503 like the sum of absolute difference (SAD). The SAD, a synchronization compensation 1511, and a delay block 1513 may suppress a spike noise caused by asynchronization.

Meanwhile, a lens actuator (not shown) has a hysteresis characteristic in which position is varied depending on direction. Disparity measured at the time of near-to-far and far-to-near movement based on an external object may have different values. A hysteresis compensation 1515 may provide a hysteresis compensation value Δz_{q}, based on a third offset value Δz_{hd} for compensating for a hysteresis characteristic. In addition, a positional difference compensation 1517 may provide a lens position compensation value Δzₚ and compensate for a positional difference of the lens.

A temperature compensation 1519 may provide a second offset value Δq₀ for compensating for the change of a refractive index dependent on a lens temperature. When the lens is made of plastic, an error caused by the change of the refractive index dependent on the temperature may be estimated by modeling through an infinite impulse response (IIR) filter and converting a temperature Ts of an image sensor into a lens temperature Tl.

As described above, the depth information obtaining unit 1500 of an embodiment may perform at least one compensation operation (at least one of 1503 to 1519). Through the compensation operation, the depth information obtaining unit 1500 may obtain a lens stroke value q. And, depth information p may be obtained by a lens model 1521.

A focal length f may eliminate a spike noise by a median filter 1523, determine a distance (main depth) of an external object 1525, and eliminate an additional noise by a temporal filter 1527.

In general, the depth information obtaining unit 1500 may obtain the depth information (p) and a distance q between an image and the lens, based on Equations 1 and 2 below.

$$\frac{1}{f} = \frac{1}{p} + \frac{1}{q} \to p = \frac{fq}{q - f} + Δ p$$

(f: Focal length [mm]
p: Depth from object to lens [mm]
q: image to lens distance [mm]
Δp (a first offset value): Depth error [mm])

$$q = {k}_{q} ( {z}_{q 0} + Δ {z}_{q} + Δ {z}_{D} + Δ {z}_{d} + Δ {z}_{p} ) + {q}_{0} + Δ {q}_{T} = {k}_{q} ( {z}_{q 0} + Δ {z}_{q} + {\underbrace{( - {α}_{d} {k}_{md 1} {D}_{p} )}}_{Δ {z}_{D}} + {\underbrace{( - Δ {z}_{d 0} - {α}_{d} {k}_{md 0} )}}_{Δ {z}_{D}} + {\underbrace{{a}_{z} Δ {z}_{pz}}}_{Δ {z}_{p}} ) + {\underbrace{{q}_{0 i} + {k}_{T} Δ {T}_{s}}}_{{q}_{0}} \qquad Equation 1$$

q: image to lens distance [mm]
z_{q0}: Current lens position [code]
Δz_{q}: Hysteresis compensation value [code]
Δz_{D}: Defocus compensation value [code]
Δz_{d}: Distortion compensation value [code]
Δzₚ: Lens position compensation value [code]
k_{q}: Lens position (z_{q}) to effective lens stroke (q) coefficient [mm/code]
q₀: Lens position (z_{q}) to Lens stroke (q) offset at 0° C. [mm]
Δq_{T}: Lens stroke difference by temperature [mm]
α_{d}: k_{md} compensation factors
k_{md1,0}: Disparity (Dₚ) to Lens position difference (Δz_{D}) coefficient by module calibration
Dₚ: Disparity [pixel]
Δz_{d0}: Difference of onfocus position from center ROI
α_{z}: Normalized z directional acceleration
Δz_{pz}: z axis directional lens movement by acceleration
q₀ᵢ: Lens position (z_{q}) to Lens stroke (q) offset at T₀ [mm]
ΔTₛ: Module calibration correction temperature [C]
k_{T}: Temperature compensation coefficient [mm/° C.]
Δt: Elapse time from sensor turn on [sec]
Tₗ(Δt): Temperature of lens [C]
[symbol] . . . Equation 2

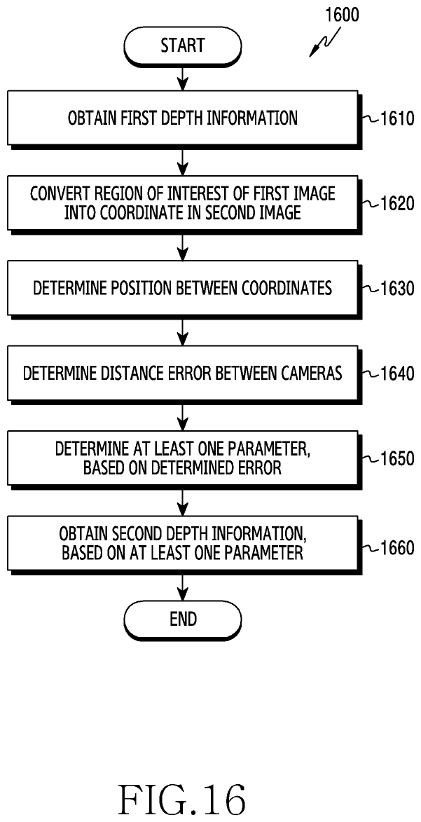

Meanwhile, in the disclosure, in addition to performing at least one compensation operation of the depth information obtaining unit 1500, a dynamic calibration function may be implemented to detect in real time a distance error between cameras occurring in an actual operation process and change a calibration coefficient, thereby addressing an issue occurring in static calibration. Hereinafter, the dynamic calibration will be described with reference to FIG. 16.

FIG. 16 is a flowchart 1600 illustrating dynamic calibration according to an embodiment of the disclosure.

Referring to FIG. 16, according to an embodiment of the disclosure, the electronic device 101 may obtain first depth information (or second depth information) at operation 1610.

According to an embodiment of the disclosure, the electronic device 101 may convert a region of interest of a first image (or second image) into a coordinate in the second image (or first image) at operation 1620. Specifically, by using a distance to an object for each region of interest of the first camera (or second camera) and a stereo camera parameter, the electronic device 101 may map to an image coordinate of the second camera (or first camera).

According to an embodiment of the disclosure, the electronic device 101 may determine a position between the coordinates at operation 1630. Specifically, by the mapping described above, the center of a region of interest of a first image (or second image) may be reflected in a coordinate of the second image (or first image). Unlike the center of a region of interest of the second image fixed, the region of interest of the first image may be mapped irregularly due to a distortion and the difference between coordinates dependent on distance. Here, the difference between the coordinates refers to the difference (caused by parallax) between positions of an object on an image caused by the difference between viewpoints of the first camera and the second camera. A distance error between the first image and the second image may be obtained for each region of interest corresponding to each object in an angle of view. To this end, operation 1630 is an operation of obtaining a region of interest of the first image (or second image) corresponding to a region of interest of the second image (or first image). The nearest neighbor may be used to select the region of interest of the first image (or second image) nearest to the region of interest of the second image (or first image) by using interpolation.

According to an embodiment of the disclosure, the electronic device 101 may determine a distance error between cameras at operation 1640. Specifically, in order to obtain a distance error between the first camera and the second camera, the electronic device 101 may average a distance of each camera with a different weight according to a location of each region of interest, reliability, and a distance to an object.

According to an embodiment of the disclosure, the electronic device 101 may determine at least one parameter, based on the determined error at operation 1650. The at least one parameter may include at least one of a first offset value Δp, a second offset value Δq₀, or a third offset value Δz_{hd}.

According to an embodiment of the disclosure, the electronic device 101 may obtain second depth information (or first depth information), based on the at least one parameter at operation 1660.

The technical task to be achieved in the disclosure is not limited to the technical tasks mentioned above, and other technical tasks not mentioned will be clearly understood by those skilled in the art to which the disclosure pertains.

An electronic device (e.g., electronic device 101 of FIG. 1) of an embodiment may include a first camera (e.g., first camera 181 of FIG. 3) supporting a first field of view (FoV), a second camera (e.g., second camera 182 of FIG. 3) supporting a second field of view having a greater angle than the first field of view, a display (e.g., the display module 160 of FIG. 1), at least one processor (e.g., processor 120 of FIG. 1) including processing circuitry, and a memory (e.g., memory 130 of FIG. 1) storing instructions. The instructions may be individually or collectively executed by the at least one processor, to allow the electronic device to, in a state where the second camera is inactivated, display a preview image on the display, based on an image obtained through the first camera, or store the image in the memory, obtain first depth information, based on phase difference information obtained using the first camera, and activate the second camera, based on a value of the first depth information being less than a first threshold. The instructions may allow the electronic device to after the second camera is activated, determine third depth information, based on at least one of the first depth information or second depth information obtained based on phase difference information obtained using the second camera, switch a camera used to display the preview image on the display or store the image in the memory, to the second camera, based on the activation of the second camera, and determine whether to switch the camera used to display the preview image on the display or store the image in the memory, to the first camera, based on the third depth information.

The instructions of an embodiment may allow the electronic device to determine at least one parameter, based on the first depth information, and obtain the second depth information from the phase difference information obtained using the second camera, based on the determined at least one parameter.

The at least one parameter of an embodiment may include at least one of a first offset value for a determined depth, a second offset value for lens stroke information, or a third offset value associated with a compensation operation for hysteresis.

The instructions of an embodiment may allow the electronic device to determine the third depth information, based on at least one of whether the first camera is in an activated state, whether the second camera is in an activated state, or a result of comparison between the first depth information and the second depth information.

The instructions of an embodiment may allow the electronic device to, after the second camera is activated, when the first camera is in an activated state, determine the first depth information as the third depth information, and inactivate the first camera in a state where the first depth information corresponds to a first reference value. The instructions may allow the electronic device to, after the first camera is inactivated, determine the first reference value as the third depth information, based on the second depth information being greater than the first reference value, and determine the second depth information as the third depth information, based on the second depth information being less than or equal to the first reference value or the difference between the second depth information and the minimum value of the second depth information being greater than a second threshold.

The instructions of an embodiment may allow the electronic device to, in a state where the first camera is inactivated and the second camera is activated, activate the first camera, based on the third depth information being greater than the second threshold, and in a state where the third depth information is a switching depth value, switch a camera used to display the preview image on the display or store the image in the memory, to the first camera, based on the activation of the first camera. The instructions may allow the electronic device to, after the first camera is activated, determine the switching depth value as the third depth information, based on the first depth information being less than the switching depth value, determine the first depth information as the third depth information, based on the first depth information being greater than or equal to the switching depth value or the difference between the maximum value of the first depth information and the first depth information being greater than or equal to a fourth threshold, and determine whether to switch the camera used to display the preview image on the display or store the image in the memory, to the second camera, based on the third depth information.

The instructions of an embodiment may allow the electronic device to obtain temperature information from an image sensor of the first camera, determine a compensation value, based on the temperature information, and obtain the first depth information, based on the determined compensation value.

The instructions of an embodiment may allow the electronic device to obtain lens position information from the first camera, synchronize the lens position information with the phase difference information obtained from the first camera, and obtain the first depth information, based on the lens position information synchronized with the phase difference information.

The instructions of an embodiment may allow the electronic device to obtain lens position information from the first camera, determine a compensation value for compensating for hysteresis for the first camera, based on the lens position information, and obtain the first depth information, based on the determined compensation value.

The instructions of an embodiment may allow the electronic device to obtain movement information about the movement of the electronic device, determine a compensation value, based on the movement information, and obtain the first depth information, based on the determined compensation value.

A method of operating an electronic device of an embodiment may include, in a state where a second camera is inactivated, displaying a preview image on a display, based on an image obtained through a first camera, or storing the image in a memory, obtaining first depth information, based on phase difference information obtained using the first camera, and activating the second camera, based on a value of the first depth information being less than a first threshold. The method may include, after the second camera is activated, determining third depth information, based on at least one of the first depth information or second depth information obtained based on phase difference information obtained using the second camera, switching a camera used to display the preview image on the display or store the image in the memory, to the second camera, based on the activation of the second camera, and determining whether to switch the camera used to display the preview image on the display or store the image in the memory, to the first camera, based on the third depth information.

The method of an embodiment may further include determining at least one parameter, based on the first depth information, and obtaining the second depth information from the phase difference information obtained using the second camera, based on the determined at least one parameter.

The at least one parameter of an embodiment may include at least one of a first offset value for a determined depth, a second offset value for lens stroke information, or a third offset value associated with a compensation operation for hysteresis.

The method of an embodiment may further include determining the third depth information, based on at least one of whether the first camera is in an activated state, whether the second camera is in an activated state, or a result of comparison between the first depth information and the second depth information.

The method of an embodiment may further include, after the second camera is activated, when the first camera is in an activated state, determining the first depth information as the third depth information, and inactivating the first camera in a state where the first depth information corresponds to a first reference value. The method may further include, after the first camera is inactivated, determining the first reference value as the third depth information, based on the second depth information being greater than the first reference value, and determining the second depth information as the third depth information, based on the second depth information being less than or equal to the first reference value or the difference between the second depth information and the minimum value of the second depth information being greater than a second threshold.

The method of an embodiment may further include, in a state where the first camera is inactivated and the second camera is activated, activating the first camera, based on the third depth information being greater than the second threshold, and in a state where the third depth information is a switching depth value, switching a camera used to display the preview image on the display or store the image in the memory, to the first camera, based on the activation of the first camera. The operating method of the electronic device may further include, after the first camera is activated, determining the switching depth value as the third depth information, based on the first depth information being less than the switching depth value, determining the first depth information as the third depth information, based on the first depth information being greater than or equal to the switching depth value or the difference between the maximum value of the first depth information and the first depth information being greater than or equal to a fourth threshold, and determining whether to switch the camera used to display the preview image on the display or store the image in the memory, to the second camera, based on the third depth information.

The method of an embodiment may further include obtaining temperature information from an image sensor of the first camera, determining a compensation value, based on the temperature information, and obtaining the first depth information, based on the determined compensation value.

The method of an embodiment may further include obtaining lens position information from the first camera, synchronizing the lens position information with the phase difference information obtained from the first camera, and obtaining the first depth information, based on the lens position information synchronized with the phase difference information.

The method of an embodiment may further include obtaining lens position information from the first camera, determining a compensation value for compensating for hysteresis for the first camera, based on the lens position information, and obtaining the first depth information, based on the determined compensation value.

The method of an embodiment further include obtaining movement information about the movement of the electronic device, determining a compensation value, based on the movement information, and obtaining the first depth information, based on the determined compensation value.

According to the disclosed embodiment of the disclosure, a function of automatic switching between a plurality of cameras may be implemented using a subject distance determined only based on camera information without using a separate distance sensor (e.g., ToF, LiDAR). Since the separate distance sensor is not required, the effects of cost and mounting space reduction and power consumption reduction may be obtained.

The effects that may be obtained from the disclosure are not limited to the effects mentioned above, and other effects not mentioned will be clearly understood by those skilled in the art to which the disclosure belongs.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first camera supporting a first field of view (FoV);
a second camera supporting a second field of view having a greater angle than the first field of view;
a display;
memory, comprising one or more storage media, storing instructions; and
at least one processor comprising processing circuitry communicatively coupled to the first camera, the second camera, the display, and the memory,
wherein the instructions, when executed by the at least one processor individually or collectively, cause the electronic device to:
in a state where the second camera is inactivated, display a preview image on the display, based on an image obtained through the first camera, or store the image in the memory,
obtain first depth information, based on phase difference information obtained using the first camera,
activate the second camera, based on a value of the first depth information being less than a first threshold,
after the second camera is activated,
determine third depth information, based on at least one of the first depth information or second depth information obtained based on phase difference information obtained using the second camera,
switch a camera used to display the preview image on the display or store the image in the memory, to the second camera, based on the activation of the second camera, and
determine whether to switch the camera used to display the preview image on the display or store the image in the memory, to the first camera, based on the third depth information.

2. The electronic device of claim 1, wherein the instructions, when executed by the at least one processor individually or collectively, further cause the electronic device to:
determine at least one parameter, based on the first depth information, and
obtain the second depth information from the phase difference information obtained using the second camera, based on the determined at least one parameter.

3. The electronic device of claim 2, wherein the at least one parameter comprises at least one of a first offset value for a determined depth, a second offset value for lens stroke information, or a third offset value associated with a compensation operation for hysteresis.

4. The electronic device of claim 1, wherein the instructions, when executed by the at least one processor individually or collectively, further cause the electronic device to:
determine the third depth information, based on at least one of whether the first camera is in an activated state, whether the second camera is in an activated state, or a result of comparison between the first depth information and the second depth information.

5. The electronic device of claim 1, wherein the instructions, when executed by the at least one processor individually or collectively, further cause the electronic device to:
after the second camera is activated,
when the first camera is in an activated state, determine the first depth information as the third depth information,
inactivate the first camera in a state where the first depth information corresponds to a first reference value,
after the first camera is inactivated,
determine the first reference value as the third depth information, based on the second depth information being greater than the first reference value, and
determine the second depth information as the third depth information, based on the second depth information being less than or equal to the first reference value or the difference between the second depth information and a minimum value of the second depth information being greater than a second threshold.

6. The electronic device of claim 5, wherein the instructions, when executed by the at least one processor individually or collectively, further cause the electronic device to:
in a state where the first camera is inactivated and the second camera is activated, activate the first camera, based on the third depth information being greater than the second threshold,
in a state where the third depth information is a switching depth value, switch a camera used to display the preview image on the display or store the image in the memory, to the first camera, based on the activation of the first camera,
after the first camera is activated,
determine the switching depth value as the third depth information, based on the first depth information being less than the switching depth value,
determine the first depth information as the third depth information, based on the first depth information being greater than or equal to the switching depth value or the difference between a maximum value of the first depth information and the first depth information being greater than or equal to a fourth threshold and
determine whether to switch the camera used to display the preview image on the display or store the image in the memory, to the second camera, based on the third depth information.

7. The electronic device of claim 1, wherein the instructions, when executed by the at least one processor individually or collectively, further cause the electronic device to:
obtain temperature information from an image sensor of the first camera,
determine a compensation value, based on the temperature information, and
obtain the first depth information, based on the determined compensation value.

8. The electronic device of claim 1, wherein the instructions, when executed by the at least one processor individually or collectively, further cause the electronic device to:
obtain lens position information from the first camera,
synchronize the lens position information with the phase difference information obtained from the first camera, and
obtain the first depth information, based on the lens position information synchronized with the phase difference information.

9. The electronic device of claim 1, wherein the instructions, when executed by the at least one processor individually or collectively, further cause the electronic device to:
obtain lens position information from the first camera,
determine a compensation value for compensating for hysteresis for the first camera, based on the lens position information, and
obtain the first depth information, based on the determined compensation value.

10. The electronic device of claim 1, wherein the instructions, when executed by the at least one processor individually or collectively, further cause the electronic device to:
obtain movement information about the movement of the electronic device,
determine a compensation value, based on the movement information, and
obtain the first depth information, based on the determined compensation value.

11. A method of operating an electronic device comprising a first camera and a second camera, the method of the electronic device comprising:
in a state where the second camera is inactivated, displaying a preview image on a display, based on an image obtained through the first camera, or storing the image in a memory;
obtaining first depth information, based on phase difference information obtained using the first camera;
activating the second camera, based on a value of the first depth information being less than a first threshold;
after the second camera is activated,
determining third depth information, based on at least one of the first depth information or second depth information obtained based on phase difference information obtained using the second camera;
switching a camera used to display the preview image on the display or store the image in the memory, to the second camera, based on the activation of the second camera; and
determining whether to switch the camera used to display the preview image on the display or store the image in the memory, to the first camera, based on the third depth information.

12. The method of claim 11, further comprising:
determining at least one parameter, based on the first depth information; and
obtaining the second depth information from the phase difference information obtained using the second camera, based on the determined at least one parameter.

13. The method of claim 12, wherein the at least one parameter comprises at least one of a first offset value for a determined depth, a second offset value for lens stroke information, or a third offset value associated with a compensation operation for hysteresis.

14. The method of claim 11, further comprising:
determining the third depth information, based on at least one of whether the first camera is in an activated state, whether the second camera is in an activated state, or a result of comparison between the first depth information and the second depth information.

15. The method of claim 11, further comprising:
after the second camera is activated,
when the first camera is in an activated state, determining the first depth information as the third depth information;
inactivating the first camera in a state where the first depth information corresponds to a first reference value;
after the first camera is inactivated,
determining the first reference value as the third depth information, based on the second depth information being greater than the first reference value; and
determining the second depth information as the third depth information, based on the second depth information being less than or equal to the first reference value or the difference between the second depth information and a minimum value of the second depth information being greater than a second threshold.

16. The method of claim 15, further comprising:
in a state where the first camera is inactivated and the second camera is activated, activating the first camera, based on the third depth information being greater than the second threshold;
in a state where the third depth information is a switching depth value, switching a camera used to display the preview image on the display or store the image in the memory, to the first camera, based on the activation of the first camera;
after the first camera is activated,
determining the switching depth value as the third depth information, based on the first depth information being less than the switching depth value;
determining the first depth information as the third depth information, based on the first depth information being greater than or equal to the switching depth value or the difference between a maximum value of the first depth information and the first depth information being greater than or equal to a fourth threshold; and
determining whether to switch the camera used to display the preview image on the display or store the image in the memory, to the second camera, based on the third depth information.

17. The method of claim 11, further comprising:
obtaining temperature information from an image sensor of the first camera;
determining a compensation value, based on the temperature information; and
obtaining the first depth information, based on the determined compensation value.

18. The method of claim 11, further comprising:
obtaining lens position information from the first camera;
synchronizing the lens position information with the phase difference information obtained from the first camera; and
obtaining the first depth information, based on the lens position information synchronized with the phase difference information.

19. The method of claim 11, further comprising:
obtaining lens position information from the first camera;
determining a compensation value for compensating for hysteresis for the first camera, based on the lens position information; and
obtaining the first depth information, based on the determined compensation value.

20. The method of claim 11, further comprising:
obtaining movement information about the movement of the electronic device;
determining a compensation value, based on the movement information; and
obtaining the first depth information, based on the determined compensation value.
